(19) United States
(12) Patent Application Publication
(10) Pub. No.: US 2020/0339149 A1
(43) Pub. Date: Oct. 29, 2020

(54) Driving device for motor vehicle, motor vehicle, and associated method of controlling such motor vehicle and computer program

(71) Applicant: TRANSDEV GROUP, Issy Les Moulineaux (FR)

(72) Inventor: Thomas DARNAUD, Versailles (FR)

(21) Appl. No.: 16/856,640

(22) Filed: Apr. 23, 2020

(30) Foreign Application Priority Data
Apr. 25, 2019 (FR) 19 04364

(51) Int. Cl. B60W 60/00; B60W 40/08; B60W 30/18

(52) U.S. Cl. CPC B60W 60/001; B60W 40/08; B60W 2540/221; B60W 2540/049; B60W 30/18163

(57) ABSTRACT

The invention relates to a driving device (40) intended to be embedded in a motor vehicle (10), in particular in an autonomous motor vehicle (10), including: a control module configured to drive the vehicle (10) as a function of a control law defining a maximum speed value of the vehicle (10) and a maximum speed variation value of the vehicle (10), a detection module configured to determine a value of at least one occupancy parameter of the vehicle (10), and a computing module configured to modify, as a function at least of the value of the determined occupancy parameter, at least one value among the maximum speed value of the vehicle (10) and the maximum speed variation value of the vehicle (10).

This application claims priority to French Patent Application 19 04364 filed Apr. 25, 2019, the entire disclosure of which is incorporated by reference herein.

### FIELD OF THE INVENTION

The present invention relates to a driving device for a motor vehicle, as well as a motor vehicle equipped with such a driving device. The present invention also relates to a driving method for such a motor vehicle. The present invention also relates to a computer program comprising software instructions that implement such a method when they are executed by a computer.

### BACKGROUND OF THE INVENTION

The invention relates to the field of autonomous motor vehicles, in particular autonomous motor vehicles having a level of automation greater than or equal to 3 on the scale of the Organisation Internationale des Constructeurs Automobiles [International Organization of Motor Vehicle Manufacturers] (OICA). These autonomous vehicles are generally controlled by a driving module that monitors the movement of the vehicle along traffic lanes according to a driving law that makes it possible to account for characteristics of the traffic lanes and of the vehicles or obstacles that are present therein. The driving module computes the trajectory, the acceleration and the speed of the autonomous vehicle according to this driving law, and controls its braking as a function of the circumstances.

The driving law is provided to ensure the safety of the occupants of the autonomous vehicle as well as of the people or other vehicles that occupy the traffic lanes when the autonomous vehicle travels therein, in particular to avoid collisions between the autonomous vehicle and obstacles present in the traffic lanes, such as pedestrians or other vehicles. The driving law therefore accounts for a large number of parameters of the environment of the vehicle.

However, the driving of the autonomous vehicles may be further improved. In particular, the driving laws of the existing autonomous vehicles are not suitable for all usage circumstances of such vehicles. In particular, a driving law that allows sufficient safety under all circumstances does not necessarily offer optimal comfort for the passengers of the autonomous vehicle. Furthermore, it still remains desirable to optimize the energy consumption of the autonomous vehicle.

### SUMMARY OF THE INVENTION

The aim of the invention is then to propose an autonomous vehicle that has improved driving, in particular allowing improved comfort for passengers and/or decreased energy consumption of the vehicle.

To that end, the invention relates to a driving device intended to be embedded in a motor vehicle, in particular in an autonomous motor vehicle, including:
a control module configured to drive the vehicle as a function of a control law defining a maximum speed value of the vehicle and a maximum speed variation value of the vehicle,
a detection module configured to determine a value of at least one occupancy parameter of the vehicle, and
a computing module configured to modify, as a function at least of the value of the determined occupancy parameter, at least one value among the maximum speed value of the vehicle and the maximum speed variation value of the vehicle.

Thus, the driving device according to the invention makes it possible to adapt the behavior of the vehicle as a function of its occupancy. This makes it possible to improve the comfort perceived by the passengers of the autonomous vehicle, and to reduce the energy consumption of the vehicle.

According to other advantageous, but optional aspects of the invention, the driving device comprises one or more of the following features, considered alone or according to all technically possible combinations:
at least one occupancy parameter is chosen from the group consisting of:
   a total number of passengers inside the vehicle,
   a number of passengers present in a predetermined location in the vehicle,
   a number of passengers belonging to a predetermined passenger category present in the vehicle, and
   a number of objects belonging to a predetermined object category present in the vehicle.
the detection module is configured to detect at least one accessory of a passenger of the vehicle and to identify, as a function of the detected accessory, a category of the passenger, preferably among a set of predetermined passenger categories.
the computing module is configured to decrease at least one of the maximum speed value of the vehicle and the maximum speed variation value of the vehicle when the detection module determines that at least one of the following properties is verified:
   at least one passenger belonging to a preselected category is present in the vehicle, or
   at least one passenger is present in a predetermined location in the vehicle.
the computing module is configured to increase at least one of the maximum speed value of the vehicle and the maximum speed variation value of the vehicle when the detection module determines that a number of passengers in the vehicle is equal to zero.
the predetermined passenger category is chosen from the group consisting of:
   a category of persons with reduced mobility,
   a category of elderly persons,
   a category of children,
   a category of persons accompanied by bulky objects, and
   a category of pregnant women.
the detection module is configured to detect an entrance into the vehicle by a passenger and to increment the total number of passengers in the vehicle, respectively configured to detect an exit from the vehicle by a passenger and to decrement the total number of passengers in the vehicle.
the vehicle is able to travel along traffic lane(s), the detection module being configured to detect persons occupying predetermined locations of the traffic lane(s) and to determine a value of at least one occupancy parameter from the performed detection.
the vehicle is configured to move over traffic lanes including a set of predetermined locations of interest, the maximum speed value of the vehicle and/or the maximum speed variation value of the vehicle being computed by the computing module as a function of the location of interest when the vehicle travels over the location of interest.

The invention also relates to a vehicle, in particular an autonomous motor vehicle, including a driving device as previously defined.

The invention also relates to a control method of an autonomous motor vehicle including an electronic driving control module configured to drive the vehicle as a function of a control law defining a maximum speed value of the vehicle and a maximum speed variation value of the vehicle, the method comprising the following steps:
determining, via an electronic detection module, a value of at least one occupancy parameter of the vehicle, and
modifying, via an electronic computing module, at least one value among the maximum speed value of the vehicle and the maximum speed variation value of the vehicle as a function at least of the value of the determined occupancy parameter.

The invention also relates to a computer program including software instructions which, when executed by a computer, implement a control method as defined above.

### BRIEF DESCRIPTION OF THE DRAWINGS

Features and advantages of the invention will appear more clearly upon reading the following description, provided solely as a non-limiting example, and done in reference to the appended drawings, in which:

FIG. 1 is a schematic illustration of a motor vehicle according to the invention, including a control module and a passenger compartment,

FIG. 2 is a schematic illustration of the vehicle of FIG. 1, showing the passenger compartment in more detail,

FIG. 3 is a schematic illustration of the control module of FIG. 1, and

FIG. 4 is a flowchart of the steps of a control method implemented by the control module of FIG. 1.

### DETAILED DESCRIPTION OF PREFERRED EMBODIMENTS

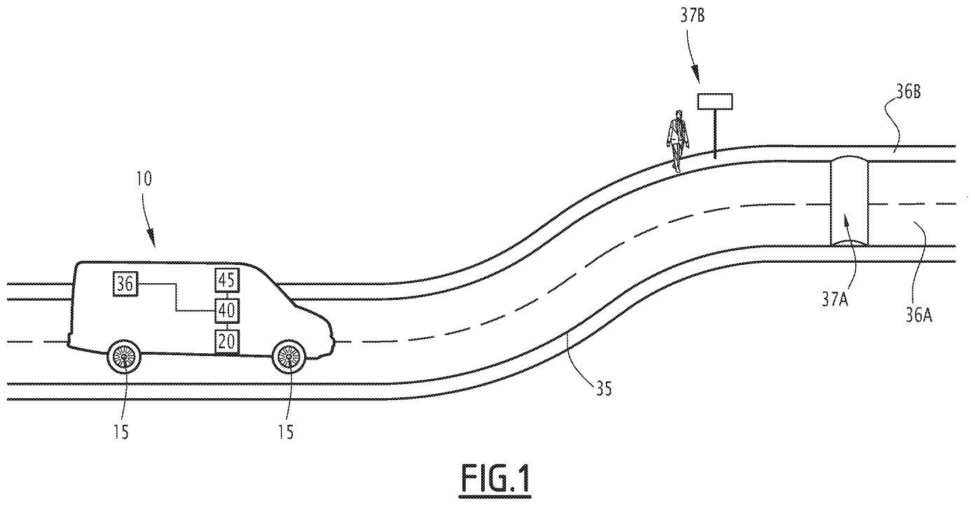

A vehicle 10 is shown in FIG. 1.

The vehicle 10 is for example a motor vehicle, in particular a bus. However, other types of motor vehicles can be considered, for example individual vehicles such as a car.

As shown in FIG. 1, each vehicle 10 comprises, in a known manner, a body 12, wheels 15, a motor 20 mechanically coupled via a transmission chain (not shown) to the wheels 15 for the driving of said wheels 15 in rotation about their axis, a steering system (not shown), suitable for acting on the wheels 15 of the vehicle 10 so as to modify the orientation of its trajectory, and a braking system (not shown), suitable for exerting a braking force on the wheels 15 of the vehicle 10.

Each motor vehicle 10 is typically made up of a traction and/or electric propulsion vehicle. To that end, the motor 20 is made up of an electric motor, and the vehicle 10 comprises an electric battery (not shown) electrically connected to the motor 20 to supply the motor 20 with electricity.

The vehicle 10 includes at least one passenger compartment 25 and an occupancy sensor 30 of the passenger compartment 25.

Each vehicle 10 is configured to move over one or more traffic lane(s) 35. The movement direction of the vehicle 10 defines a longitudinal axis A-A′. The vehicle 10 extends along the longitudinal axis A-A′.

Each motor vehicle 10 is for example an autonomous vehicle. To that end, the motor vehicle 10 comprises an electronic autonomous driving device 40 suitable for driving the vehicle 10 over the traffic lane 35 autonomously by receiving information on the environment of the vehicle 10 by means of at least one sensor 45, also called environment sensor, and by acting on the motor 20, the steering system and the braking system, so as to modify the speed, the acceleration and the trajectory of the vehicle 10 in response to the received information. Each environment sensor 45 is for example a camera, a temperature sensor, a pressure sensor, a humidity sensor or a lidar. Each environment sensor 45 is connected to the electronic autonomous driving device 40.

For example, the electronic autonomous driving device 40 is configured to control a braking of the vehicle 10 when environment sensor 45 detects the presence of another vehicle in front of the vehicle 10 in question, a distance between the two vehicles being less than or equal to a predetermined threshold, this threshold in particular depending on the speed of the vehicle 10.

Each autonomous motor vehicle 10 preferably has a level of automation greater than or equal to 3 on the scale of the Organisation Internationale des Constructeurs Automobiles (OICA). The level of automation is then equal to 3, that is to say, a conditional automation, or equal to 4, that is to say, a high automation, or equal to 5, that is to say, a full automation.

According to the OICA scale, level 3 for conditional automation corresponds to a level for which the driver does not need to perform continuous monitoring of the driving environment, while still having to be able to take back control of the autonomous motor vehicle 10. According to this level 3, a system for managing the autonomous driving, on board the autonomous motor vehicle 10, then performs the longitudinal and lateral driving in a defined usage case and is capable of recognizing its performance limits to then ask the driver to take back dynamic driving with a sufficient time margin.

The high level of automation 4 then corresponds to a level for which the driver is not required in a defined usage case. According to this level 4, the system for managing the autonomous driving, on board the autonomous motor vehicle 10, then performs the dynamic longitudinal and lateral driving in all situations in this defined usage case.

The full automation level 5 lastly corresponds to a level for which the system for managing the autonomous driving, on board the autonomous motor vehicle 10, performs the dynamic lateral and longitudinal driving in all situations encountered by the autonomous motor vehicle 10, throughout its entire journey. No driver is then required.

The traffic lanes 35 for example include a roadway 36A on which the vehicle 10 is provided to travel, and one or several sidewalks 36B provided to allow pedestrian circulation.

The traffic lanes 35 then in particular include at least one predetermined location of interest 37A, 37B.

Each location of interest 37A, 37B is a location that the electronic autonomous driving device 40 is configured to take into account specifically during the driving of the vehicle 10.

At least one location of interest is, for example, a speedbump 37A configured to encourage or force the vehicles traveling on the roadway to slow down upon approaching the speedbump. The speedbump 37A is, for example, a hump, that is to say, a speedbump 37A including at least one raised portion relative to the surrounding surface of the roadway.

In a variant or additionally, at least one location of interest is a roundabout, an intersection or a turn.

In a variant or in addition, at least one location of interest is a zone of the traffic lanes 35 provided to accommodate at least one pedestrian and to allow the vehicle 10 to stop such that the pedestrian enters the vehicle 10 or such that the pedestrian exits it. For example, the location is a stop 37B. The stop 37B is in particular embodied by a panel on the sidewalk 36B and/or by a marking on the ground of the sidewalk 36B or the roadway 36A.

In a variant, the zone is a zone with no marking, but in which a pedestrian has indicated to the electronic autonomous driving device 40 that the pedestrian is waiting for the vehicle 10 to stop to allow the pedestrian to enter the vehicle 10 or to exit it. For example, the pedestrian has sent coordinates of the zone to the electronic autonomous driving device 40 via a radiofrequency datalink, in particular via a mobile terminal such as a mobile telephone. The coordinates for example include GPS coordinates, or a reference of the zone able to identify the zone among a set of predetermined zones stored in the electronic autonomous driving device 40.

In a variant, at least one location of interest is an intersection between traffic lanes 35 including a traffic light or a STOP sign, an intersection between the traffic lanes 35 and a railroad track, a zone including a pedestrian crosswalk crossing the traffic lanes or a portion of the traffic lanes 35 including a speed limit relative to the other portions of the traffic lanes 35.

Each passenger compartment 25 is able to receive at least one passenger 50A, 50B, 50C, 50D, for example a plurality of passengers 50A, 50B, 50C, 50D.

According to the example shown in FIG. 1, the vehicle 10 includes a single passenger compartment 25. In a variant, the vehicle 10 includes a plurality of passenger compartments 25 that are separate from one another.

Each passenger compartment 25 for example includes at least one passenger 50A, 50B, 50C, 50D service equipment item 55A, 55B.

Each service equipment item is a passenger 50A, 50B, 50C, 50D service equipment item of a corresponding passenger compartment 25. For example, at least one passenger service equipment item is an equipment item usable by a passenger of the passenger compartment 25. In a variant, at least one service equipment item is an equipment item provided to interact with a passenger 50A, 50B, 50C, 50D of the passenger compartment 25.

According to the example of FIG. 1, each passenger compartment 25 includes a plurality of passenger service equipment items.

Each passenger service equipment item is for example chosen from the group consisting of:
a display device 55A,
an acoustic device 55B,
an equipment item for regulating the temperature,
a power outlet, and
a bulb.

It should be noted that other types of passenger service equipment items may be considered.

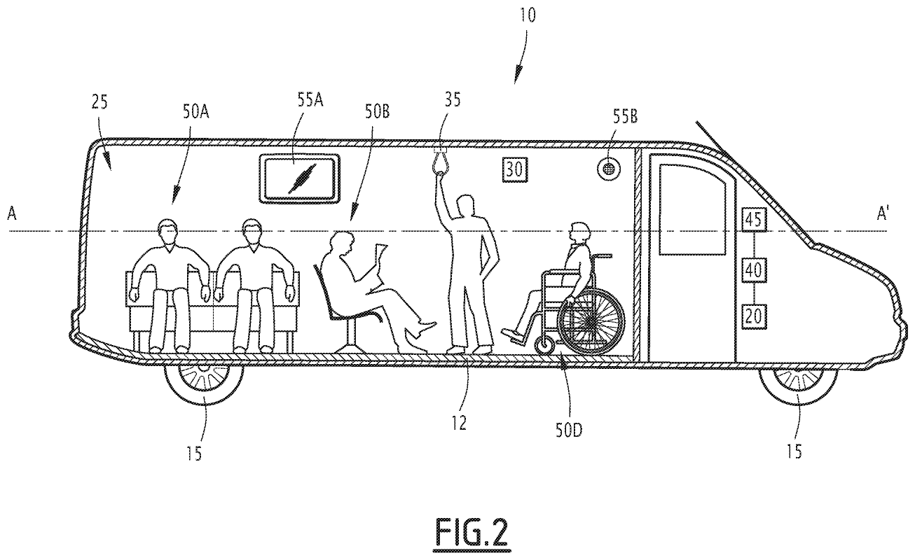

In FIG. 2, a display device 55A and an acoustic device 55B are shown, but embodiments in which other passenger 50A, 50B, 50C, 50D service equipment items are present in the passenger compartment 25 may also be considered. In particular, it should be noted that types of passenger service equipment items other than display devices 55A, acoustic devices 55B, temperature regulating equipment items, power outlets and bulbs may be present in the passenger compartment 25.

Each occupancy sensor 30 is able to provide at least one information item relative to the presence of one or several passenger(s) 50A, 50B, 50C, 50D inside the vehicle 10. Each occupancy sensor 30 is, for example, chosen from the group consisting of: an image sensor, in particular a stereoscopic sensor, a presence sensor, a sound sensor, an infrared sensor, a weight sensor and a temperature sensor.

In a variant, at least one occupancy sensor 30 is configured to provide at least one information item relative to the presence of one or several person(s) occupying one or several locations of interest, in particular zones 37B of the traffic lanes 35. For example, the occupancy sensor 30 is configured to detect the presence of one or several persons occupying a zone 37B, in particular a portion of a sidewalk 36B comprised in a zone 37B. In this case, a same sensor is able to serve as occupancy sensor 30 and environment sensor 45, thus reducing the complexity of the vehicle 10.

In a variant or in addition, at least one occupancy sensor 30 is configured to detect one or several passenger(s) 50A, 50B, 50C, 50D entering or exiting the vehicle 10.

Each occupancy sensor 30 is connected to the electronic autonomous driving device 40.

The electronic autonomous driving device 40 includes at least a control module 60, a detection module 65, a computing module 70 and an information processing module 75 including a processor 80 and a memory 85.

The control module 60 is configured to drive the vehicle 10 over the traffic lanes 35 as a function of information provided by the environment sensor(s) 45. In particular, the control module 60 is configured to drive the vehicle 10 according to a control law.

The control law is able to allow the control module 60 to determine, as a function of information supplied by the environment sensor(s) 45, a trajectory, a speed and/or an acceleration of the vehicle 10 over the traffic lanes 35.

The control law defines a maximum speed value and at least one maximum speed variation value of the vehicle 10.

The maximum speed value is in particular a speed value that the vehicle 10 must not exceed over the portion or the location 37A of the traffic lanes 35 over which the vehicle 10 is traveling.

“Speed variation” refers to a variation of the speed of the vehicle 10 as a function of time, i.e., a drift of the speed relative to time. The maximum variation value is for example a maximum acceleration value, that is to say, a positive variation of the speed, or a maximum deceleration value, that is to say, a negative variation of the speed.

According to one embodiment, the control law defines a maximum speed value, a maximum acceleration value and a maximum deceleration value.

Each maximum value is for example defined in absolute value.

In a variant or in addition, the control law is further able to determine a range of permitted values for the speed, the acceleration and/or the deceleration of the vehicle 10 when the vehicle 10 travels over a location of interest.

In particular, the control law is able to determine a range of permitted values for the speed, the acceleration and/or the deceleration of the vehicle 10 when the vehicle 10 travels over a location of interest chosen from the group made up of: speed bumps, roundabouts, intersections including a traffic light and intersections including a STOP sign. The detection module 65 is configured to determine a value of at least one occupancy parameter of the vehicle 10. In particular, the detection module 65 is configured to determine the value of each occupancy parameter of the vehicle 10 as a function of the information sent by the occupancy sensor(s) 30.

Each occupancy parameter is for example chosen from the group consisting of:
a total number of passengers 50A, 50B, 50C, 50D inside the vehicle 10,
a number of passengers 50A, 50B, 50C, 50D belonging to a predetermined passenger 50A, 50B, 50C, 50D category present in the vehicle 10,
a number of passengers 50A, 50B, 50C, 50D present in a predetermined location in the vehicle 10, and
a number of objects belonging to a predetermined object category present in the vehicle 10.

For example, the detection module 65 is configured to detect an entry by a passenger 50A, 50B, 50C, 50D into the vehicle 10 and to increment the total number of passengers 50A, 50B, 50C, 50D in the vehicle 10 in response. Furthermore, the detection module 65 is configured to detect an exit by a passenger 50A, 50B, 50C, 50D from the vehicle 10 and to decrement the total number of passengers 50A, 50B, 50C, 50D in the vehicle 10 in response.

Each passenger 50A, 50B, 50C, 50D category is for example chosen from the group consisting of:
children,
the elderly,
standing persons,
seated persons,
persons accompanied by bulky objects,
pregnant women,
persons with reduced mobility, and
persons having purchased a transport ticket belonging to a predetermined category of transport tickets.

It should be noted that other categories of passenger 50A, 50B, 50C, 50D may also be considered.

For example, the detection module 65 is configured to detect the presence of one or several passengers 50A, 50B, 50C, 50D in the vehicle 10, in particular in a passenger compartment 35, and to identify one or several categories of the or each passenger 50A, 50B, 50C, 50D as a function of information provided by the occupancy sensor(s) 30.

In a variant, the detection module 65 is configured to detect the presence of one or several person(s) in a predetermined location of the traffic lane(s) and to identify one or several categories associated with the person(s) from information provided by an environment sensor 45, and to determine the values of an occupancy parameter as a function of the identified category or categories when the person enters the vehicle 10.

For example, at least one category, in particular the category of persons with reduced mobility, is associated with at least one accessory. The detection module 65 is configured to detect such an accessory when a passenger 50A, 50B, 50C, 50D is equipped with this accessory and as a result to classify the passenger 50A, 50B, 50C, 50D in the category associated with this accessory. Thus, the category of the passenger 50A, 50B, 50C, 50D is identified.

In one advantageous embodiment, when at least one of the occupancy sensors 30 in the vehicle 10 is an image sensor, the detection module 65 is configured to classify the passenger(s) 50A, 50B, 50C, 50D by processing of image(s) coming from the image sensor associated with a machine learning method.

The machine learning method is for example based on a model using a statistical approach in order to make it possible to improve the performance of this method to resolve tasks without being explicitly programmed for each of these tasks. The machine learning includes two phases. The first phase consists of defining a model from data present in a database, called observations. The estimation of the model in particular consists of recognizing the presence of one or several objects in an image. This so-called learning phase is generally carried out before the practical use of the model. The second phase corresponds to the use of the model: the model being defined, new images can then be submitted to the model in order to obtain the object(s) detected in said images.

In particular, the machine learning method is able to detect accessories associated with the passenger 50A, 50B, 50C, 50D and characteristics of a category of the passenger 50A, 50B, 50C, 50D, such as a cane or a wheelchair associated with reduced mobility of the passenger 50A, 50B, 50C, 50D.

The machine learning model for example includes the implementation of a neural network. A neural network is generally made up of a series of layers, each of which takes its inputs from the outputs of the previous one. Each layer is made up of a plurality of neurons, taking their inputs from the neurons of the previous layer. Each synapse between neurons has an associated synaptic weight, such that the inputs received by a neuron are multiplied by this weight, and then said neuron is added. The neural network is optimized owing to the adjustments of the different synaptic weights during the learning phase as a function of the images present in the initial database.

According to one embodiment, the detection module 65 is configured to detect persons occupying predetermined locations of the traffic lanes 35, in particular of the zones 37B, and to determine the value of at least one occupancy parameter from said detection. For example, the detection module 65 is configured to detect the entry or exit of a passenger into or from the vehicle 10 after the detection of a person occupying said zone 37B.

In particular, the detection module 65 is configured to detect a person occupying the predetermined location before the vehicle 10 reaches the location and stops there, and to increment the total number of passengers in the vehicle 10 as a function of the number of persons detected in the location. Furthermore, the detection module 65 is configured to detect a person occupying the predetermined location after the vehicle 10 has stopped in said location, and to decrement the total number of passengers in the vehicle 10 as a function of the number of persons detected in the location after the vehicle 10 has stopped.

The predetermined object category or categories for example comprise bulky objects such as suitcases, strollers, bags and/or bicycles.

The bulky objects are, for example, identified by image analysis.

In a variant or additionally, at least one object category is a category for heavy objects. The heavy objects are for example identified by image analysis.

The number of passengers 50A, 50B, 50C, 50D present in a predetermined location in the vehicle 10 for example comprises a number of passengers 50C, 50D present in a location with no seats. An aisle between two rows of seats, or a free space provided to be occupied by a person in a wheelchair or by a stroller are examples of locations with no seats.

In a variant or additionally, the number of passengers 50A, 50B, 50C, 50D present in a predetermined location in the vehicle 10 for example comprises a number of passengers 50A seated in seats perpendicular to the longitudinal axis A-A′ of the vehicle 10, or a number of passengers 50B seated in seats parallel to the longitudinal axis A-A′. “Perpendicular seat” (“parallel seat”, respectively) relative to the longitudinal axis A-A′ refers to a seat provided so that a passenger 50A, 50B seated in the seat faces a side wall of the vehicle 10 (respectively faces the front or the back of the vehicle 10).

The computing module 70 is configured to modify at least one value among the maximum speed value and the maximum speed variation value(s) of the control law as a function of the value of at least one occupancy parameter determined by the detection module 65.

For example, the computing module 70 is configured to decrease at least one value among the maximum speed value and the maximum speed variation value(s) as a function of the determined value.

In particular, the computing module 70 is configured to modify the maximum speed value between a first maximum speed value and a second maximum speed value that is strictly lower than the first maximum speed value as a function of the value of at least one occupancy parameter.

The first maximum speed value is, for example, between 85 kilometers per hour (km/h) and 90 km/h when the vehicle 10 travels over a portion of the traffic lanes 35 in which the speed is limited to 90 km/h.

The first maximum speed value is, for example, a function of a location of interest in which the vehicle 10 is traveling. For example, the first maximum speed value is strictly higher when the vehicle 10 is traveling over a straight portion of the traffic lanes 35 than when the vehicle 10 is traveling over a location of interest chosen from the group made up of: a roundabout, a turn, an intersection including a traffic light or a stop sign, a speed bump, an intersection between the traffic lanes 35 and a railroad track, a zone including a pedestrian crosswalk.

The first maximum speed value is for example chosen to limit the energy consumption of the vehicle 10 and/or to limit the travel time of the vehicle 10.

The second maximum speed value is for example between 90% and 95% of the first maximum speed value.

The second maximum speed value is, for example, between 80 km/h and 85 km/h when the vehicle 10 travels over a portion of the traffic lanes 35 in which the speed is limited to 90 km/h.

The second maximum speed and/or speed variation value is, for example, a function of a location of interest 37A in which the vehicle 10 is traveling. For example, the second maximum speed and/or speed variation value is strictly higher when the vehicle 10 is traveling over a straight portion of the traffic lanes 35 at the second maximum speed and/or speed variation value [than] when the vehicle 10 is traveling over a location of interest 37A chosen from the group made up of: a roundabout, a turn, an intersection including a traffic light or a stop sign, a speed bump, an intersection between the traffic lanes 35 and a railroad track, a zone including a pedestrian crosswalk.

Furthermore, the computing module 70 is configured to modify a maximum speed variation value between a first maximum speed variation value and a second maximum speed variation value that is strictly lower than the first maximum speed variation value as a function of the value of at least one occupancy parameter.

The first maximum speed variation value is for example chosen to limit the energy consumption of the vehicle 10 and/or to limit the travel time of the vehicle 10.

The computing module 70 is for example configured, when the number of passengers 50A, 50B, 50C, 50D is equal to zero, to
set the maximum speed value equal to the first maximum speed value; and/or
set each maximum speed variation value equal to the corresponding first maximum speed variation value.

The first maximum speed variation value may vary depending on the circumstances.

The second maximum speed variation value is for example, in absolute value, between 80% and 95% of the first maximum speed variation value.

According to one embodiment, the computing module 70 is configured to modify a maximum acceleration value between a first maximum acceleration value and a second maximum acceleration value that is strictly lower than the first maximum acceleration value as a function of the value of at least one occupancy parameter.

The computing module 70 is further configured to modify a maximum deceleration value between a first maximum deceleration value and a second maximum deceleration value that is strictly lower than the first maximum deceleration value as a function of the value of at least one occupancy parameter.

In particular, the computing module 70 is configured to make at least one of the maximum speed value, the maximum acceleration value and the maximum deceleration value equal to the corresponding second maximum value when the detection module 65 determines that at least one of the following properties is verified:
at least one passenger 50A, 50B, 50C, 50D belonging to a preselected category is present in the vehicle,
at least one passenger 50A, 50B, 50C, 50D is present in a predetermined location in the vehicle 10, or
the number of passengers 50A, 50B, 50C, 50D in the vehicle 10 is equal to zero.

For example, the computing module 70 is configured to make at least one of the maximum speed value, the maximum acceleration value and the maximum deceleration value equal to the corresponding second maximum value when the detection module 65 determines that at least one passenger 50A, 50B, 50C, 50D is classified in one of the categories in the following group: persons with reduced mobility, elderly persons, children, pregnant women, persons accompanied by bulky objects, standing persons.

In particular, the computing module 70 is configured to make each of the maximum speed value and the maximum deceleration value equal to the corresponding second maximum value when the detection module 65 determines that at least one passenger 50A, 50B, 50C, 50D is classified in one of the categories in the following group: persons with reduced mobility, elderly persons, children, pregnant women, persons accompanied by bulky objects, standing persons.

In a variant or in addition, the computing module 70 is configured to make the at least one of the maximum speed value, the maximum acceleration value and the maximum deceleration value respectively be equal to a third maximum speed value, a third maximum acceleration value or a third maximum deceleration value when the detection module 65 determines that the vehicle 10 includes a number of passengers strictly greater than zero, in particular that no passenger is classified in a predetermined category such as one of the categories belonging to the following group: persons with reduced mobility, elderly persons, children, pregnant women, persons accompanied by bulky objects, standing persons.

For example, the computing module 70 is configured to make at least one of the maximum speed value, the maximum acceleration value and the maximum deceleration value equal to the corresponding third maximum speed, acceleration or deceleration value.

The third maximum speed value is strictly between the first maximum speed value and the second maximum speed value.

The third maximum acceleration value is strictly between the first maximum acceleration value and the second maximum acceleration value. The third maximum deceleration value is strictly between the first maximum deceleration value and the second maximum deceleration value.

In a variant or in addition, the computing module 70 is further configured to modify at least a first range of values among a range of permitted values for the speed, the acceleration and/or the deceleration of the vehicle 10 when the vehicle 10 is traveling over a location of interest, in particular to replace the first range of values with a second range of values, the values of which are different from the values of the first range of values. In particular, the values of the second range of values are strictly lower than the values of the first range of values.

The specific location is for example a roundabout, a turn, an intersection including a traffic light or a stop sign, a speedbump, an intersection between the traffic lanes 35 and a railroad track, a zone including a pedestrian crosswalk.

In a variant or in addition, the computing module is further configured to generate a deactivation command intended for a passenger 50A, 50B, 50C, 50D service equipment item 55A, 55B when the detection module 65 determines that the total number of passengers 50A, 50B, 50C, 50D is equal to zero.

For example, at least one equipment item chosen from a display device 55A, an acoustic device 55B, a temperature regulating device, a power outlet and a bulb is deactivated by the computing module 70. In particular, a power supply of the equipment item is interrupted.

In a variant or in addition, the computing module is further configured to generate a deactivation command intended for a power outlet when the detection module 65 determines that at least one child is present in the vehicle 10.

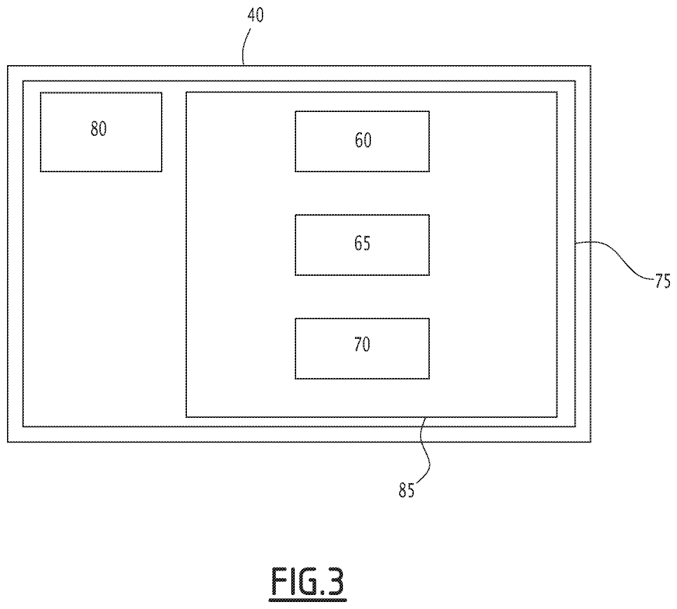

As shown in FIG. 3, the control module 60, the detection module 65 and the computing module 70 are each made in the form of software, or a software component, executable by the processor 80. The memory 85 is then able to store control software, detection software and computing software. The processor 80 is then able to execute each piece of software.

In a variant that is not shown, the control module 60, the detection module 65 and the computing module 70 are each made in the form of a programmable logic component, such as an FPGA (Field Programmable Gate Array), or in the form of a dedicated integrated circuit, such as an ASIC (Application Specific Integrated Circuit).

When the electronic autonomous driving device 40 is made in the form of one or several software programs, i.e., in the form of a computer program, it is further able to be stored on a medium, not shown, readable by computer. The computer-readable medium is for example a medium suitable for storing electronic instructions and able to be coupled with a bus of a computer system. As an example, the readable medium is an optical disc, a magnetic-optical disc, a ROM memory, a RAM memory, any type of non-volatile memory (for example, EPROM, EEPROM, FLASH, NVRAM), a magnetic card or an optical card. A computer program including software instructions is then stored on the readable medium.

It should be noted that although the vehicle 10 has been described above in the case where the detection module 65, the computing module 70 and the occupancy sensor(s) 30 are embedded in the vehicle 10, embodiments in which at least one of these elements is not embedded, for example in which at least one of these elements is positioned along traffic lanes 35, can also be considered.

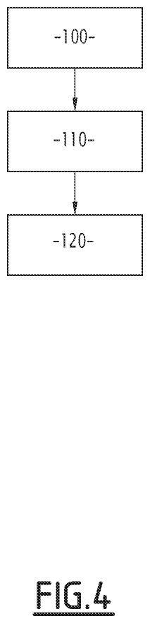

The operation of the vehicle 10 will now be described using FIG. 4, showing a flowchart of the steps of a method, according to the invention, for controlling the vehicle 10, the method being implemented by the electronic autonomous driving device 40.

The method comprises an acquisition step 100, a determining step 110 and a computing step 120.

During the acquisition step 100, information relative to the presence of one or several passengers 50A, 50B, 50C, 50D inside the vehicle 10 is transmitted by at least one occupancy sensor 30 and/or at least one environment sensor 45 to the detection module 65.

For example, an occupancy sensor 30 acquires one or several image(s) of a passenger compartment 35 and sends the image(s) to the detection module 65.

In a variant or additionally, an environment sensor 45 acquires one or several image(s) of a location of interest of the traffic lanes and sends the image(s) to the detection module 65 when the vehicle 10 stops in the location of interest to allow at least one passenger 50A, 50B, 50C, 50D to enter or exit.

As an optional addition, an occupancy sensor 30 detects the entry or exit of the passenger(s) and sends the detection module 65 an information item relative to the number of passengers having entered the vehicle 10 and/or exited the vehicle 10.

During the detection step 110, the detection module 65 determines the value of at least one occupancy parameter of the vehicle from the received information item(s).

For example, the detection module 65 determines a total number of passengers 50A, 50B, 50C, 50D in the vehicle 10.

In a variant or additionally, the detection module 65 classifies at least one passenger 50A, 50B, 50C, 50D in at least one passenger 50A, 50B, 50C, 50D category. In this case, the detection module 65 for example determines, for at least one passenger 50A, 50B, 50C, 50D category, a number of passengers belonging to this passenger 50A, 50B, 50C, 50D category.

In a variant or additionally, the detection module 65 determines a number of passengers 50A, 50B, 50C, 50D present in a predetermined location of the vehicle 10, or a number of objects belonging to one or several predetermined object categories present in the vehicle 10.

For example, in the case illustrated in FIG. 2, the detection module 65 determines that:
the total number of passengers 50A, 50B, 50C, 50D is equal to five;
three passengers 50A, 50B are classified in the category of seated persons,
one passenger 50C is classified in the category of standing persons,
one passenger 50D is classified in the category of persons with reduced mobility,
two passengers 50C, 50D are present in a location devoid of seats,
two passengers 50A are seated on seats perpendicular to the longitudinal axis A-A′ of the vehicle 10, and
one passenger 50B is seated on a seat parallel to the longitudinal axis A-A′.

During the computing step 120, the computing module 70 modifies the control law as a function at least of the value of the determined occupancy parameter.

In particular, the computing module 70 modifies at least one value among the maximum speed value, the maximum acceleration value and/or the maximum deceleration value of the vehicle 10.

For example, since at least one passenger 50D is classified in the category of persons with reduced mobility, the computing module 70 makes the maximum speed value equal to the second maximum speed value. The computing module 70 further makes the maximum deceleration value equal to the second maximum deceleration value.

For example, if it is assumed that the vehicle 10 was empty before the acquisition step 100 and that the passengers 50A to 50D entered the vehicle 10 just before the acquisition step, the maximum speed, acceleration and deceleration values were then set by the computing module 70, before the acquisition step 100, as respectively being equal to the first maximum speed value, the first maximum acceleration value and the first maximum deceleration value.

During the computing step 70, the computing module 70 decreases the maximum speed value from the first maximum speed value to the second maximum speed value. The computing module 70 further decreases the maximum deceleration value from the first maximum deceleration value to the second maximum deceleration value.

If no passenger 50A, 50B, 50C, 50D was classified in one of the categories belonging to the following group: persons with reduced mobility, elderly persons, children, pregnant women, persons accompanied by bulky objects, standing persons, in particular if the person with reduced mobility 50D and the standing person 50C were not present, during the computing step 70, the computing module 70 would then decrease at least one maximum value among the maximum speed, acceleration and deceleration values from the first maximum value to the corresponding third maximum value.

As an optional addition, the computing module 70 controls the deactivation, in particular the interruption of a power supply to a passenger 50A, 50B, 50C, 50D service equipment item 55A, 55B.

It should be noted that, when the maximum speed, acceleration and/or deceleration values are equal to the second or third corresponding maximum values, and the detection module 65 detects, during the detection step 110, that no passenger 50A to 50D is present in the vehicle 10, the computing module 70 then increases at least one among the maximum speed, acceleration and/or deceleration values to make it equal to the corresponding first maximum value during the computing step 120.

Owing to the invention, the behavior of the vehicle is adapted as a function of its occupancy. This makes it possible to improve the comfort perceived by the passengers of the autonomous vehicle, and to reduce the energy consumption of the vehicle.

The number of passengers present in a predetermined location in the vehicle and/or the number of objects or passengers belonging to a predetermined object or passenger category are occupancy parameters which, when taken into account, make it possible to improve passenger comfort. The total number of passengers is an occupancy parameter which, when taken into account, makes it possible to decrease the energy consumption of the vehicle.

Decreasing the maximum speed value and/or the maximum speed variation value(s) when one or several passengers are present belonging to predetermined categories and/or are present in predetermined locations makes it possible to improve the perceived comfort of these passengers.

Conversely, increasing the maximum speed variation value(s) in case of absence of passenger in the vehicle 10 makes it possible to decrease the energy consumption of the vehicle. Indeed, if the maximum speed variation value is low, braking and acceleration operations must be implemented very early, which means that in many cases, they are done on a precautionary basis, whereas it would ultimately have been possible to keep a constant speed due to the later evolution of the situation. These braking and acceleration operations then cause a needless increase in the energy consumption of the vehicle.

In general, the more constant the speed, the lower the energy consumption of the vehicle. Waiting before triggering a speed variation, which is made possible owing to a high speed variation value, therefore makes it possible to limit the energy consumption.

In general, taking occupancy parameters into account to modify the maximum speed and/or speed variation values therefore makes it possible both to improve passenger comfort and to optimize the energy consumption of the vehicle 10.

Furthermore, when the maximum speed value is reduced when the vehicle 10 is traveling over a predetermined location, in particular when this predetermined location is a turn or a speed bump, passenger comfort is improved.

The detection of an entry or exit of a passenger and the corresponding modification of the total number of passengers may be done using simple sensors 30 and does not require complex processing of the information provided by the sensors. The complexity of the device 40, the sensor(s) 30 and more generally the vehicle 10 is then reduced.

When the detection module 65 determines values of occupancy parameters from the detection of persons present in locations of interest of the traffic lanes, the classification of the passengers into categories may be done based on information, in particular images, supplied by the environment sensor(s) 45 or by one or several sensors positioned along the traffic lanes 35, which causes the vehicle 10 to require fewer environment sensors 30, and is therefore simplified.

When the computing 70 or detection 75 modules are embedded in the vehicle 10, the vehicle 10 is less sensitive to a potential loss of communications with the outside of the vehicle 10, and its operation is made more reliable.

1. A driving device intended to be embedded in a motor vehicle, including:
a control module configured to drive the vehicle as a function of a control law defining a maximum speed value of the vehicle and a maximum speed variation value of the vehicle,
a detection module configured to determine a value of at least one occupancy parameter of the vehicle, and
a computing module configured to modify, as a function at least of the value of the determined occupancy parameter, at least one value among the maximum speed value of the vehicle and the maximum speed variation value of the vehicle.

2. The driving device according to claim 1, wherein at least one occupancy parameter is chosen from the group consisting of:
a total number of passengers inside the vehicle,
a number of passengers present in a predetermined location in the vehicle,
a number of passengers belonging to a predetermined passenger category present in the vehicle, and
a number of objects belonging to a predetermined object category present in the vehicle.

3. The driving device according to claim 2, wherein the detection module is configured to detect at least one accessory of a passenger of the vehicle and to identify, as a function of the detected accessory, a category of the passenger.

4. The driving device according to claim 3, wherein the category is identified among a set of predetermined passenger categories.

5. The driving device according to claim 2, wherein the computing module is configured to decrease at least one of the maximum speed value of the vehicle and the maximum speed variation value of the vehicle when the detection module determines that at least one of the following properties is verified:
at least one passenger belonging to a preselected category is present in the vehicle, or
at least one passenger is present in a predetermined location in the vehicle.

6. The driving device according to claim 2, wherein the computing module is configured to increase at least one of the maximum speed value of the vehicle and the maximum speed variation value of the vehicle when the detection module determines that a number of passengers in the vehicle is equal to zero.

7. The driving device according to claim 2, wherein at least one acquisition parameter is a number of passengers belonging to a predetermined passenger category present in the vehicle, the predetermined passenger category being chosen from the group consisting of:
a category of persons with reduced mobility,
a category of elderly persons,
a category of children,
a category of persons accompanied by bulky objects, and
a category of pregnant women.

8. The driving device according to claim 1, wherein the detection module is configured to detect an entrance into the vehicle by a passenger and to increment the total number of passengers in the vehicle, respectively configured to detect an exit from the vehicle by a passenger and to decrement the total number of passengers in the vehicle.

9. The driving device according to claim 1, wherein the vehicle is able to travel along traffic lane(s), the detection module being configured to detect persons occupying predetermined locations of the traffic lane(s) and to determine a value of at least one occupancy parameter from the performed detection.

10. The driving device according to claim 1, wherein the vehicle is configured to move over traffic lanes including a set of predetermined locations of interest, the maximum speed value of the vehicle and/or the maximum speed variation value of the vehicle being computed by the computing module as a function of the location of interest when the vehicle travels over the location of interest.

11. The driving device according to claim 1, wherein the motor vehicle is an autonomous motor vehicle.

12. A motor vehicle including a driving device according to claim 1.

13. The motor vehicle of claim 12, wherein the motor vehicle is an autonomous motor vehicle.

14. A method for controlling an autonomous motor vehicle including an electronic control module configured to drive the vehicle as a function of a control law defining a maximum speed value of the vehicle and a maximum speed variation value of the vehicle, the method comprising the following steps:
determining, via an electronic detection module, a value of at least one occupancy parameter of the vehicle, and
modifying, via an electronic computing module, at least one value among the maximum speed value of the vehicle and the maximum speed variation value of the vehicle as a function at least of the value of the determined occupancy parameter.

15. A computer program comprising software instructions which, when executed by a computer, carry out a method according to claim 14.
